(19) United States
(12) Patent Application Publication
(10) Pub. No.: US 2010/0086818 A1
(43) Pub. Date: Apr. 8, 2010

(54) RECOOLING AND HUMIDIFICATION DEVICE FOR USE IN FUEL CELLS

(75) Inventors: Gerhard Konrad, Ulm (DE); Heiner Kunckel, Heroldstatt (DE)

Correspondence Address: PATENT CENTRAL LLC;Stephan A. Pendorf, 1401 Hollywood Boulevard, Hollywood, FL, 33020, US

(73) Assignee: Daimler AG, Stuttgart (DE)

(21) Appl. No.: 12/523,590

(22) PCT Filed: Jan. 8, 2008
(86) PCT No.: PCT/EP2008/000063

§ 371 Date: Jul. 17, 2009

(30) Foreign Application Priority Data
Jan. 22, 2007 (DE) 10 2007 003 240.6

(51) Int. Cl. H01M 8/04

(52) U.S. Cl. 429/26

(57) ABSTRACT

The invention relates to devices for operating fuel cells. According to the invention, the two functions “cooling” and “humidification” are combined in a functional unit (11, 12) to adjust the temperature of the air (1) supplied as the reaction medium and to humidify it, wherein the known hollow fiber design for membrane humidifiers having a high specific surface can preferably be used for the charge air cooler (3). These hollow fibers may also consist of a temperature-resistant membrane material (5) and give off water vapor to the inlet gas.

The invention relates to a fuel cell system. The invention especially relates to devices for the temperature adjustment and humidification of air supplied to the fuel cell as reaction medium.

Fuel cells (BZ) need the observance of a certain region of the operating temperature for an optimal operation. To observe this region, at least one part of the exhaust gas of the fuel cell is returned to the gas inlet according to the document DE 195 48 297 C2, and the temperature of the returned exhaust gas is thereby adjusted. From DE 199 23 738 C2, it is known to feed the cathode of a fuel cell with compressed air. If the air is compressed by means of a compressor, the temperature of the air increases hereby. Thus, in a fuel cell system of this type, the cathode supply air has to be cooled again to a necessary operating temperature region.

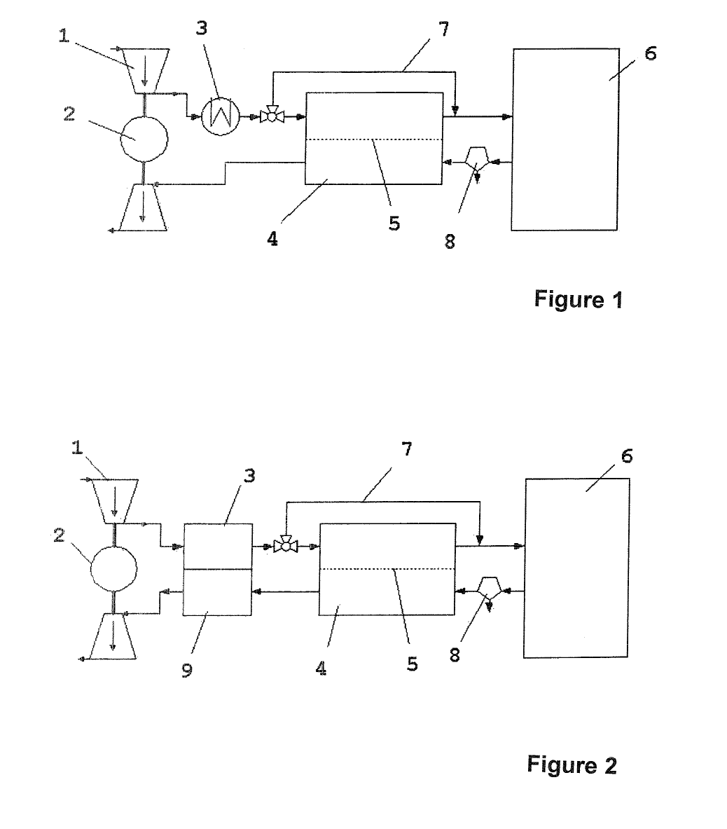

In FIG. 1, the air supply is shown schematically in correspondingly equipped PEMFC systems (proton exchange membrane fuel cell) according to the current state of the art. The inlet air (1) is initially compressed in the compressor (2) and then recooled in the charge air cooler (3) by means of cooling water. In the further course, the air flows into the humidifier module (4), where it absorbs water vapor from the exhaust gas of the fuel cell (6) via membranes (5). The humidity content can be controlled with the bypass (7) around the humidifier. The air is then directed into the fuel cell (6) and there takes part in the electrochemical reaction. Fluid water which is possibly present is precipitated from the exhaust gas flow after the reaction in the stack by the condensate precipitator (8) and the remaining exhaust gas is again supplied to the humidifier module (4) where it delivers water vapor to the inlet gas via the membranes. After the humidifier module, the exhaust gas is relaxed in the turbine (2) and discharged to the environment.

The cooling of the air (1) before the humidifier (4) is necessary, as humidifier membranes (5) with a sufficient transfer performance are currently only offered up working temperatures up to 120° C., however, the compression end temperatures of the air after passing through the compressor can be up to 175° C.

The necessity of the cooling water supply of the charge air cooler and the further heat discharge via the vehicle cooler is disadvantageous in this arrangement. The exhaust gas additionally leaves the humidifier in certain operating situations with high relative humidity, which leads to condensate formation in front of or in the turbine and thus to damage of the turbine bearings and turbine blades, and to exhaust plumes.

In the published patent application DE 10 2004 046 922 A1 in the name of the applicant, a modified arrangement for supplying fuel cells is introduced, where the compressed inlet gas is cooled by the exhaust gas of the fuel cell. The temperature of the exhaust gas in front of the turbine increases thereby in a countermove, so that a condensate formation is reduced.

FIG. 2 shows the diagram of such a fuel cell system. after the compressor (2), the inlet air (1) flows through the gas-gas charge air cooler (3) and is precooled there by the BZ exhaust gas by means of heat exchanger (9). Furthermore, the air reaches the humidifier (4) of known design, where it is again humidified by the BZ exhaust gas. It then reaches the BZ stack, takes part in the electrochemical reaction and leaves this again as exhaust gas, which passes the above arrangement in a counterflow.

The invention is based on the above-mentioned state of the art. It is based on the object to develop a device for recooling and humidification of the inlet air for fuel cells, which enables a compact construction and efficient control.

This object is solved with a device having the characteristics of the preamble of claim 1 by the characterizing characteristics of claim 1. Further details and advantageous embodiments of the device according to the invention are the object of the dependent claims.

The invention is explained in more detail in the following by means of examples of embodiments with reference to the drawings and the reference numerals given therein.

It shows thereby:

FIG. 1 a diagram of the current air supply line in the PEMFC system

FIG. 2 a diagram of the air supply line with charge air cooling by BZ exhaust gas

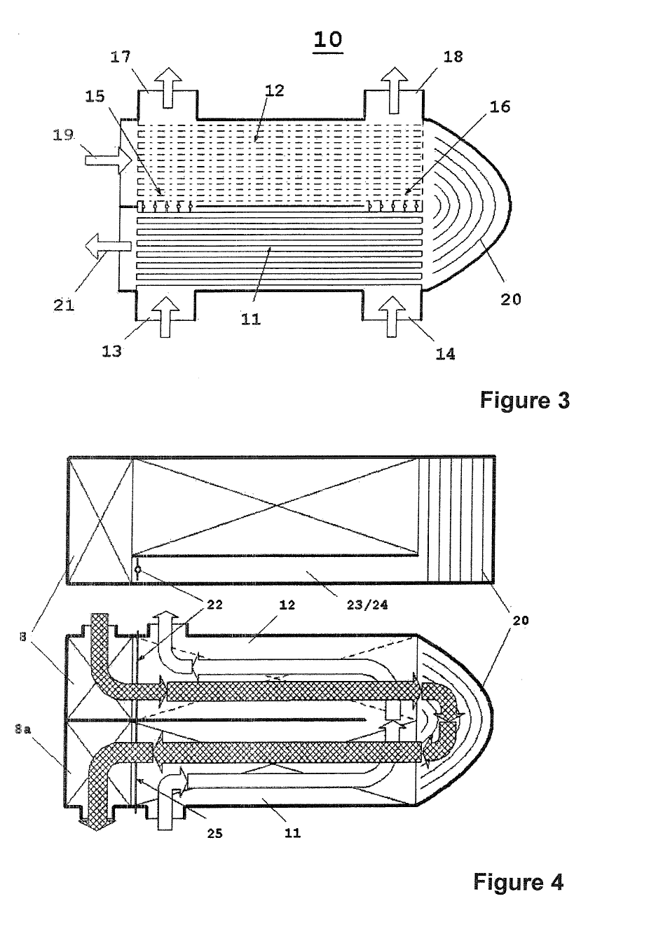

FIG. 3 a first embodiment of the water vapor and heat exchanger according to the invention

FIG. 4 a second embodiment of the water vapor and heat exchanger according to the invention

The invention suggests to combine the two functions “cooling” and “humidification” in a functional unit, where the known hollow fiber design for membrane humidifiers having a high specific surface can be adopted. These hollow fibers can also consist of temperature-resistant membrane material and also release water vapor to the inlet gas.

In FIG. 3 is shown a first embodiment of the device according to the invention. The water vapor heat exchanger (10) consists here of two hollow fiber bundles (11, 12), one with a high thermal stability (membrane bundle 11) for precooling the inlet gas, and one of water vapor-permeable membrane material (12) for water vapor transfer. The compressed inlet gas flows into the shell area of the “heat exchanger bundle” (11) through one or both inlets (13, 14), from this it reaches the shell area of the “humidifier membrane bundle” via the controllable flap registers (15) and/or (16), and finally out of the water vapor heat exchanger through one or both outlets (17, 18). The fuel cell exhaust gas reaches the interior of the humidifier hollow fibers (12) via the inlet (12) flows through these, is deflected in the top part (20), and directed to the outlet (21) through the heat transfer part (11), from which it leaves the apparatus.

The following operating conditions can be controlled in a stepless manner with the controllable flap registers (15, 16) and by controlling the the inflow of the gases to the inlets (13, 14; 19, 21):

a) high heat transfer, high water transfer,

b) high heat transfer, low water transfer,

c) low heat transfer, high water transfer,

d) low heat transfer, low water transfer.

The fuel cell can thereby be adjusted very quickly to optimal operating conditions, even with varying outer conditions.

In FIG. 4 is shown a further embodiment of the device according to the invention, where the control of the above-mentioned operating conditions takes place via the flow guidance of the BZ exhaust gas. A vertical longitudinal section is shown in the upper part of the figure. In this embodiment, the arrangements in the humidifier space and the heat exchanger are designed identical in construction and the longitudinal section respectively shows the center region for both partial regions (11, 12).

The shaded arrows of FIG. 4 depict the BZ exhaust gas, the white arrows depict the inlet gas. From the exhaust gas flowing in from above in the drawing, the drops are initially precipitated in the first condensate precipitator (8), and the condensed water is discharged. The exhaust gas, controlled by the shown flap (22), then either flows into the membrane packet (12) for the humidification of the inlet gas, or through the bypass channel (23). Behind the bypass channel (23), the gas can either flow past the heat exchanger (11) in a further bypass channel (24), or through it. The flap (25) at the inlet into the second condensate precipitator (8a) serves for controlling this flow direction. The exhaust gas flows out of the module after the second condensate preciptitator. The inlet gas is initially directed through the heat exchanger (12) and then through the humidification membrane packet (11) in counterflow.

A combined and structurally compact unit for fuel cells is provided by the invention with the functions “heat transfer” and “humidification and dehumidification”. The different partial functions can thereby be controlled independently from one another in this functional unit. The properties of the supply and the exhaust gases can thereby be adjusted to the desired operating conditions of the fuel cell within extensive limits. The manufacturing effort for a fuel cell system is reduced by the combination of different functions in one device.

1. A fuel cell system with at least one fuel cell (6), especially a PEMFC fuel cell, with a inlet air inlet (1), a subsequent compressor (2), and means (3) for cooling the compressed inlet air and means (4) for the humidification of the inlet air via membranes (5), where exhaust air of the fuel cell (6) is used for cooling and humidification by returning behind a condensate precipitator (8), wherein the two functions “cooling” and “humidification” are combined in one functional unit (10), which is formed as a double chamber system (11, 12), of which one chamber serves as a heat exchanger (11), and the second chamber as a membrane humidifier (12), and where inlet/outlet connections are arranged in such a manner, that the exhaust air first flows through the membrane humidifier, and subsequently through the heat exchanger (11) and the inlet air is directed in the counterflow direction.

2. The system according to claim 1, wherein means (15, 16; 22, 25; 23, 24) are present for the independent control of the gas flows.

3. The system according to claim 1, wherein membrane bundles of temperature-resistant hollow fiber membranes are used for the heat exchanger (11) and/or the membrane humidifier (12).
